(19) United States
(12) Patent Application Publication
(10) Pub. No.: US 2017/0189252 A1
(43) Pub. Date: Jul. 6, 2017

(54) ADJUSTABLE PORTABLE MOBILITY SYSTEM

(71) Applicant: Simply Ingenious Products, LLC, Gainesville, FL (US)

(72) Inventor: Adam Daniel Silver, Gainsville, FL (US)

(73) Assignee: Simply Ingenious Products, LLC, Gainesville, FL (US)

(21) Appl. No.: 15/313,977

(22) PCT Filed: May 14, 2015
(86) PCT No.: PCT/US15/30766

§ 371 Date: Nov. 25, 2016

Related U.S. Application Data
(60) Provisional application No. 62/002,879, filed on May 25, 2014.

(51) Int. Cl. A61G 5/14; A47C 7/54; A47C 31/00; A61G 7/10

(52) U.S. Cl. CPC A61G 5/14; A61G 7/1038; A47C 7/546; A47C 31/00

(57) ABSTRACT

A device for facilitating movement of a user between upright and seated positions relative to a piece of furniture such as a couch is disclosed. The device includes at least one portion to be gripped by the user and at least two stabilizing the device under the furniture cushions during operation thereof.

### CROSS-REFERENCE TO RELATED APPLICATION

This is a US National Phase Application under 35 USC §365, which is based on and claims priority to PCT/US2015/030766, filed May 14, 2015, which claims priority to U.S. Provisional Patent Application No. 62/002,879, filed May 25, 2014, the entirety of which is hereby incorporated by reference.

### BACKGROUND

Mobility assistance systems are invaluable not only for aged and infirmed but also for those undergoing any form of rehabilitation, those with weight problems, pregnancy, and those with leg and lower back weakness that resulting in difficulty moving between the seated and standing positions. Historically, however, these systems are deliberately configured for only a limited utility. For example, there are systems to assist persons in moving between seated and standing position in bathrooms such as illustrated in U.S. Pat. No. 8,402,572 issued on Mar. 26, 2013. The entirety of this patent is hereby incorporated by reference. The system as illustrated is affixed to the toilet bowl for stability as is conventional. Other “bathroom” type systems are bulky and use the floor for stability, but they must be extremely wide to accommodate the size of the toilet bowl and thus have essentially no other utility. In addition, of course, horizontal and vertical bars referred to as “grab bars” are well known but these are affixed to the wall and thus have no utility except in those places where they are physically attached.

Systems to prevent persons from falling out of bed are generally known, and these may be collapsible. One such system is illustrated in U.S. Patent Application Publication 2012/01174926, published May 17, 2012. The entirety of this document is also hereby incorporated by reference.

The most frequent daily activity, however, is not the use of the toilet or lying in bed, but rather it is moving between seated and standing positions. The above-described systems are of essentially ineffective to this regard.

### SUMMARY

In accordance with a first aspect of the present disclosure, there is provided a device for a facilitating movement of a user between upright and seated positions. The device is mountable on a piece of furniture and includes a first tubular section; first and second elbows rotatably connected to the first tubular section; first and second tubular arms respectively coupled to the first and second elbows; and a first stabilizer rotatably coupled to the first tubular arm and a second stabilizer rotatably coupled to the second tubular arm. This configuration enables the device to be mounted on the piece of furniture by placing the first tubular section on a support surface, rotating the first and second elbows relative to the first tubular section so that the first tubular section, first elbow and second elbow are aligned in a first, plane, rotating the first and second tubular arms at the first and second elbows to position the first and second tubular arms into respective second and third planes, and rotating the first and second stabilizers at an angle relative to at least one of the second and third planes underneath a cushion of the furniture.

In accordance with another aspect of the present disclosure, a device is provided for facilitating movement of a user between upright and seated positions. The device is mountable on a piece of furniture and includes a U-shaped tubular section including an elongated center portion; a first stabilizer rotatably coupled to a first end of the U-shaped tubular section and a second stabilizer rotatably coupled to a second end of the U-shaped tubular section. The device can be mounted on the furniture by rotating the first and second stabilizers at an angle relative to a longitudinal axis of the elongated center portion of the U-shaped tubular member, and positioning each stabilizers under at least one cushion of the furniture on a support surface.

### BRIEF DESCRIPTION OF THE DRAWINGS

These and other aspects of the present disclosure will become more apparent upon reading the following detailed description with particular reference to the accompanying drawings. In the drawings, like reference numerals are used to indentify corresponding components and the components are merely intended to be illustrative and not to scale:

FIG. 1 is a perspective illustration of one form of the present device;

FIG. 2 illustrates the present device in a collapsed position;

FIG. 3 illustrates one use of the present device in connection with, a typical piece of furniture with furniture cushions removed for clarity;

FIG. 4 illustrates use of the present device in connection with a typical piece of furniture with furniture cushions properly positioned;

FIG. 5 is a partial perspective illustration of one form of the present device with an attachment in place;

FIG. 6 is a partial illustration of an aperture and detent to provide adjustability of the present system;

FIG. 7 is a partial illustration of the use of a single mobility device and;

FIG. 8 is a partial illustration of the use of a single mobility device.

### DETAILED DESCRIPTION

Referring now to the various figures of the drawings, an adjustable portable mobility device 10 will initially be described as including various components with, the understanding that components and/or functions may be combined as will be appreciated by those skilled in the art and therefore no specific number of discrete parts are required. Thus the reference to components is purely for explanatory purposes. In addition, identifications that use words such as upper/lower, larger/smaller, left/right, first/second front/back, etc., are for explanatory non-limiting purposes.

The components are described as tubes which may be of circular cross-section, again for convenience, it being understood that the cross-section is not limited depending upon desired functionality.

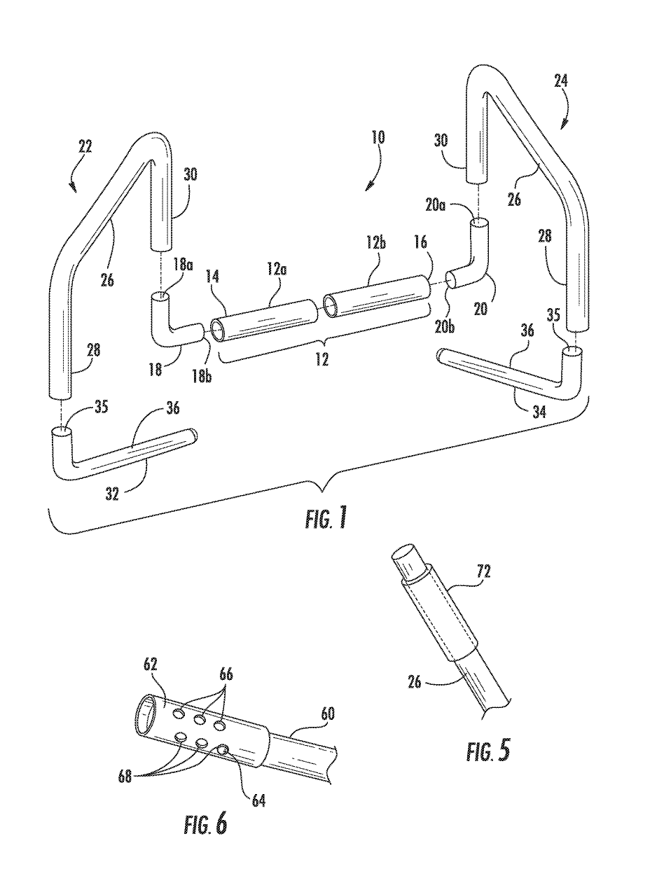

The system is illustrated and described in a non-limiting manner as including three generally U-shaped or C-shaped members, although other configurations may be used. Referring first to FIG. 1, a U-shaped member of the system preferably includes tube 12 (formed of aligned tubes 12a and 12b) being generally straight and each having a longitudinal axis thus forming the base of the U-shape. The benefit of using two (or more) tubes 12a, 12b, is for overall adjustability in the length of the tube 12 although a single tube of a fixed length is also contemplated. The overall length of the tube 12 forms the base of a U-shaped member and the tube 12 includes first and second ends 14, 16. A right angle or elbow shaped tube 18 is connected to the first end 14 of the tube 12, specifically, tube 18 has ends 18a and 18b with end 18b connected to the first end 14 of tube 12. Similarly, a second right angle or elbow shaped tube 20 is connected to the second 16 of the tube 12, specifically , tube 20 has ends 20a and 20b with end 20b connected to the second end 16 of tube 12. Preferably the diameters of tubes 18 and 20 are sized relative to the diameter of tube 12 so that they are inter-fitted and rotatable relative to each other. It should be pointed put that the length of tubes 18 and 20 relative to the length of other tubes is not to scale but is shown for illustrative purposes. The greater the length of the arms of the tubes 18 and 20, the greater the potential effective length or spacing between tubes 22 and 24 and thus the greater the adjustability of that length or spacing. In the orientation of FIG. 1, one longitudinal axis of each tubes 18 and 20 extends upwardly at right angles to the longitudinal axis or tube 12, and tubes 12, 18 and 20 are in the same place such that they form a generally U-shape. It should be understood, however, that a single U-shaped tube may be provided instead of multiple tubes as just described. The use of multiple tubes 12a, 12b provides adjustability in length along the longitudinal axis of the first U-shaped member. This is described in more detail in connection with FIG. 6. The adjustability in length of tube 12 may also be accomplished by the length of tubes 18 and 20 (specifically the length of the portions of those tubes that are to be inserted into ends 14 and 16 of tube 12 as well as the depth of such insertion.

Remaining with FIG. 1, the system may include two additional generally U-shaped tubes 22, 24, illustrated in a non-limiting sense as downwardly opening and on the left and right sides of the system. Each of tubes 22 and 24 has a base 26 and downwardly extending first and second legs 28, 30. Leg 30 of tube 22 is inter-fitted with tube 18 and leg 30 of tube 24 is inter-fitted with tube 20. Each of the U-shaped tubes 22, 24 may be formed as a single component or from multiple components such as a straight portion and two elbow or right angle portions and furthermore, the base 26 of each tube 22, 24 may be formed of multiple, aligned tubes thus providing adjustability in length along the longitudinal axis of each of tubes 22, 24. Additionally, the legs 28, 30 of tube 22 (and the legs 28, 30 of tube 24) may also be formed from multiple tubes. Again, this will be described in greater detail in connection with FIG. 6.

FIG. 1 further illustrates two additional elbow or right angle tubular components 32, 34. Each of components 32, 34 has a first end 35 inter-fitted with tubes 22 and 24, respectively, and each of components 32, 34 has a second or free end 36. The free ends 36 may be of any desired length for additional stability. As an alternative, additional tubes may be inserted into ends 36 of tubes 32, 34 for stability purposes. In the orientation of FIG. 1, the base of U-shaped tubes 22, 24 have longitudinal axes that may be parallel to each other and may be perpendicular to the longitudinal axis of the base of tube 12. As an alternative, the base of U-shaped tubes 22, 24 may be positioned at an incline relative to the longitudinal axis of the base of tube 12. Since the U-shaped tubes 22, 24 are independently adjustable they are preferably but not necessarily parallel.

The free ends 36 of tubes 32, 34 may be oriented at an angle relative to the plane of tubes 22, 24, respectively. In addition, the free ends 36 of tubes 32, 34 may be thought of as oriented at an angle relative to a plane formed by tube 22 and legs 30 of tubes 22 and 24. This orientation provides for increased stability.

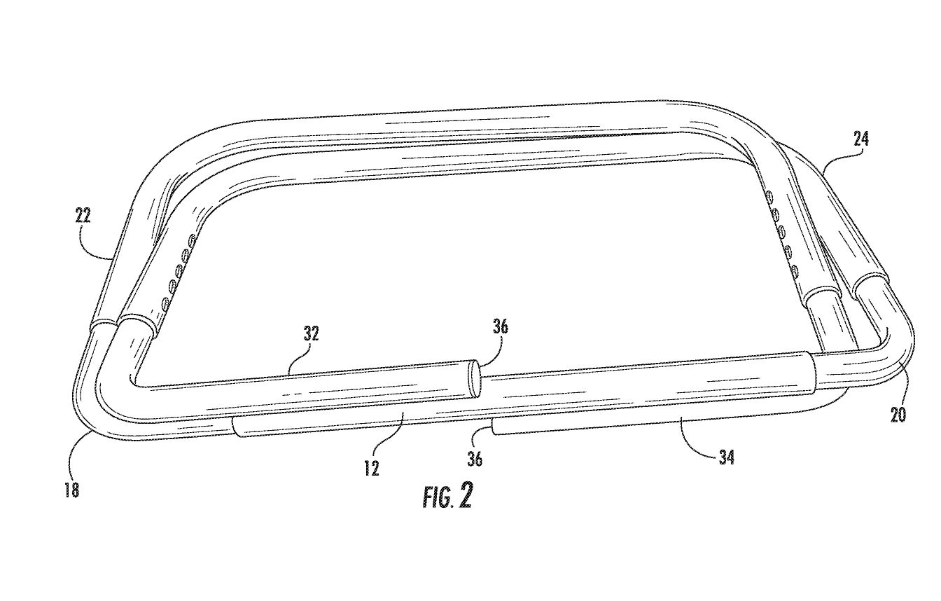

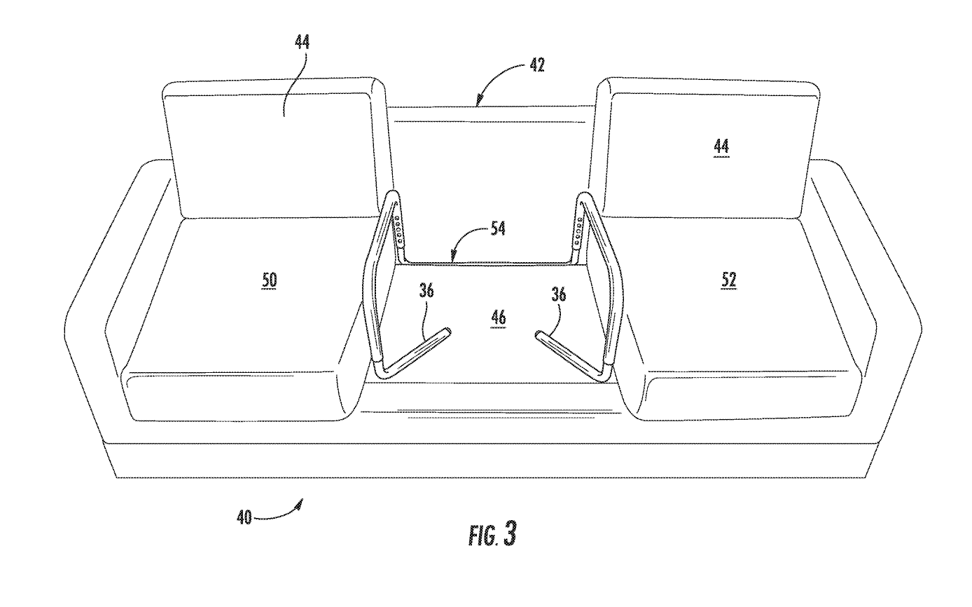

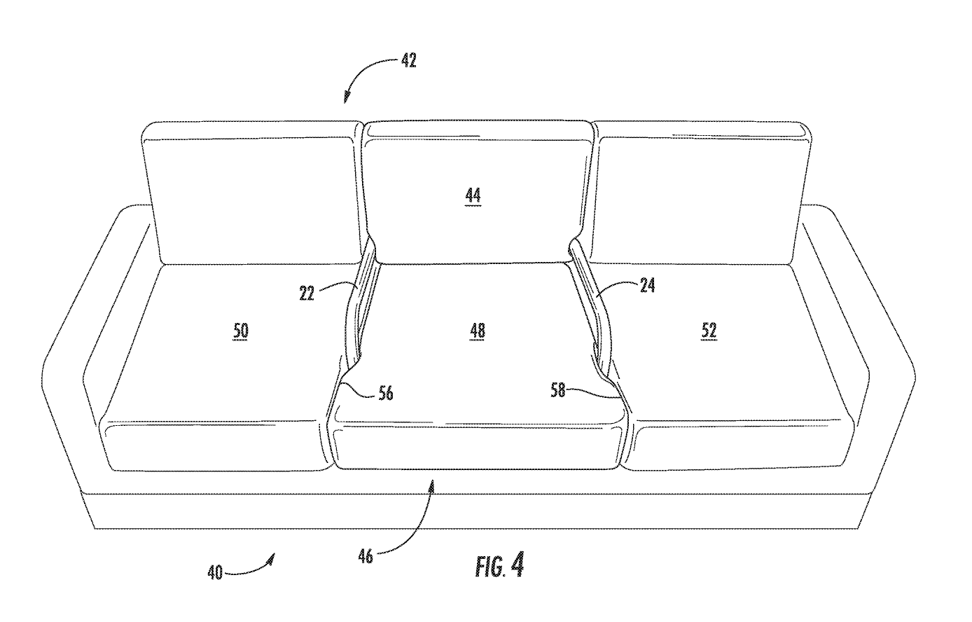

Referring to FIG. 2, the system is illustrated in a collapsed or folded configuration which is achieved by, for example, rotating free ends 36 into the plane of the respective tubes 32, 34, and rotating tubes 32, 34 into the plane formed by tubes 12, 22, 24. Alternative collapsed or folded configurations may be achieved based on the rotational inter-fit of the various components FIG. 3 and FIG. 4 illustrate one form of use of the present system in the context of a conventional piece of furniture such as a sofa or couch 40 having a back 42 with at least one back cushion 44, and a seat portion 46 having at least one removable seat cushion 48. The back cushion 44 is removed for clarity of illustration. Additional seat cushions 50, 52, are illustrated on the seat portion 46 such that if all seat cushions were in position, seat cushion 48 would be intermediate seat cushions 50 and 52. It should be appreciated that the present system is not limited to be placed under a middle cushion. For ease of explanation, a space 54 is defined as the area between the seat portion 46 and the back 42, a space 56 is defined as the area between seat cushions 48 and 50 (when all seat cushions are in position) and a space 58 is defined as the area between seat cushions 48 and 52 (when all seat cushions are in position). In FIG. 3, one U-shaped portion 12 is placed in space 54, tubes 32 and 34 are placed in spaces 56 and 58, respectively, and free ends 36 are angled relative to the plane of tubes 32 and 34. In FIG. 4, back cushions 44 and seat cushion 48 have been put back in position and only portions of tubes 22, 24 are visible. Stability is provided to the system because of the positioning of the rear U-shaped tube in the space 54. Lateral stability is provided to the system because of the positioning of the left and right U-shaped tubes in spaces 56 and 58. Even further stability to the system is provided by the weight of the user sitting on cushion 48 and thus exciting force on the tree ends 36 of the tubes 32 and 34. The free ends 36 thus function as additional stabilizing members. All these stabilizing forces negate any torque caused by the arms of the user as the user moves between upright and seated position. The left and right tubes 22, 24 are typically gripped by the user to provide support during movement (in either direction) between standing and seared position.

In the event that the furniture does not have a removable seat cushion, the free ends 36 are rotated into the plane of the tubes 32, 34 and the tubes 32, 34 may be placed in spaces between non-removable cushions and/or the space between a cushion and the armrest of a couch.

Although the degree of stability may be decreased, the system may be used in connection with a chair, whether or not the chair includes a removable seat cushion.

The tubes may be made of metal or plastic (PVC, for example), carbon fiber or any other material having the strength for the intended purpose. The cross-sectional configuration need not be circular depending, of course, on whether it is desired to have the system easily collapsible by rotation of the tubes. If the tubes are of square cross-section, for example, the tubes may be easily separated and placed in a collapsed configuration and may be reassembled when desired.

Referring next to FIG. 5, the system may be provided with one or more convenience attachments. For example, a cushioned grip 72 may be provided on tube 26 (only one is illustrated) and the cushioned grip may take one of many forms including but not limited to foam, fabric or a roughened surface on a tube. If fabric is used, it may be initially in the form of a rectangular sheet with hook and eye fasteners such that when the sheet is wrapped around the tube, the sheet attaches to itself. Alternatively a fabric or foam may be initially in the form of a hollow tube that may be slid onto tube 23. Other convenience attachments such as food trays, cup holders and the like may also be provided on the tubes 22, 24. It should be appreciated further that the attachments may be placed or any tube as desired.

For enhanced convenience and adjustability, tubes may be provided with spring loaded detents with corresponding apertures on adjacent tubes. This will assist in securing tubes in position without accidental rotation as well as provide for adjustability in the length of each tube. Thus, with reference to FIG. 1 and FIG. 6 for example, tube 12 could be formed of tubes 12a and 12b with one of those tubes including spring loaded detents and the other of those tubes including a series of apertures. Spring loaded detents( with corresponding apertures) may be provided wherever two tubes are to be secured together.

To illustrate this further, FIG. 6 includes a representative configuration of tubes 60, 62, with tube 60 including a spring loaded detent 64, and tube 62 have a series of spaced apart apertures 66 in one longitudinal row and a second series of spaced apart apertures 68 in a second longitudinal row offset circumferentially from the first row. By use of circumferentially offset rows of apertures, the relative rotational position of adjacent tubes may be accommodated. By use of spaced apart apertures in a single longitudinal row, the relative length of adjacent tubes may be adjusted.

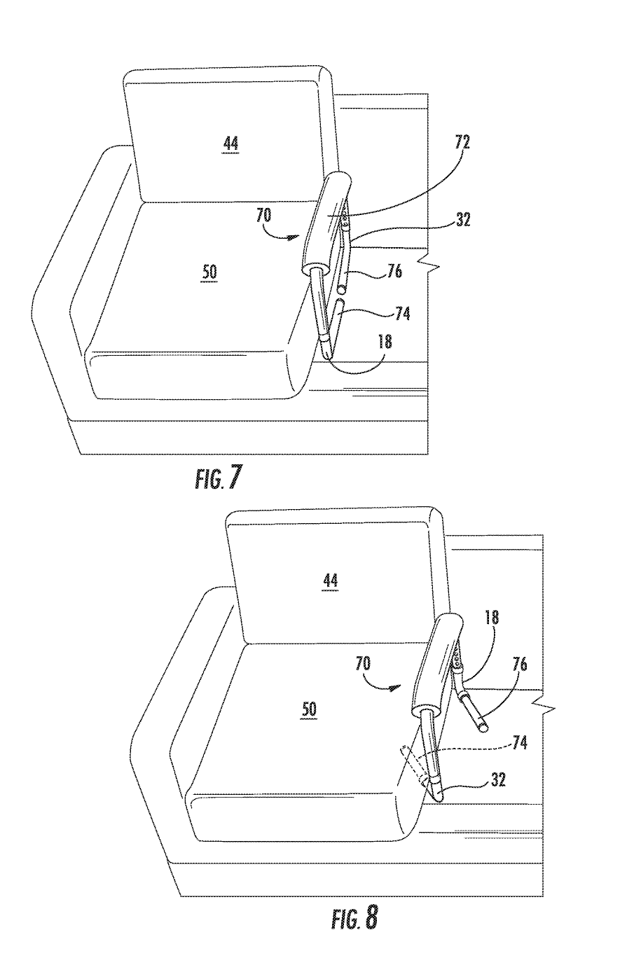

The embodiment of FIG. 1, as described above, may be thought of as three sections, left, right and rear. Each section maybe adjusted independently of the other section as to width (side-to-side), height (top-to-bottom) and depth (front-to-back). The left (or right) section may be used independently of the rear section as will now be described. FIG. 7 and FIG. 8 each include a single adjustable, portable mobility system positioned on a sofa where a back cushion 44 and a seat cushion 50 are illustrated and where adjoining seat and back cushions have been removed for clarity of illustration. The system 70 corresponds generally to either the left or right tubes 22, 24 of FIG. 1 with the horizontal leg of elbows 18, 20, having greater length than is illustrated in FIG. 1 although, as pointed out, the various Figures are illustrate and not to scale. (For clarity of illustration, all references numerals are not shown in FIG. 7 and FIG. 8.) Thus, in FIG. 7 and FIG. 8, the system 70 could include, for example, the tube 22 with front and rear depending tubes 28, 30, (from FIG. 1) and with elbow tubes 32 and 18 therein (or the similarly identified components associated with tube 24). In FIG. 7 and FIG. 8, elbow tube 32 is provided with a vertical section to fit into tube end 28 (as in FIG. 1) and an elongated free end 74 and elbow tube 18 is provided with a vertical section to fit into tube end 30 (as in FIG. 1) and an elongated free end 76. This is exemplary only as the corresponding parts of tube 24 may be used. As explained in the context of FIG. 1, extensions may be attached to one or more of the free ends 74, 76 for increased stability.

Each of the elbow tubes and the tube 22 may he provided with detents and apertures, as appropriate, for vertical height adjustment. The free ends 74, 76 are pivotable and may be in the same plane as tube 22 (FIG. 7) or at an angle relative to the plane of tube 22 where either tube end may be rotated under seat cushion 50 and the other tube end may be rotated to be placed under the seat cushion that has been removed for ease of illustration (FIG. 8). A second alternative is for both free ends 74, 76 to be rotated into position under the cushion 50. A third alternative is for both free ends 74, 76 to be rotated outwardly to be positioned under an adjoining cushion. The configuration of FIG. 7 and FIG. 8 is more of a C-shaped configuration than a U-shaped configuration but the principles of operation, adjustability, portability, and stability are the same.

The foregoing is a complete non-limiting description of the present system. Various changes and modifications will now be apparent to those of ordinary skill in the art.

What is claimed is:

1. A device for facilitating movement of a user between upright and seated positions or laying and seated positions, the device mountable on a piece of furniture and comprising:
a first tubular section;
first and second elbows rotatably connected to the first tubular section;
first and second tubular arms respectively coupled to the first and second elbows; and
a first stabilizer rotatably coupled to the first tubular arm and a second stabilizer rotatably coupled to the second tubular arm,
whereby, the device may be mounted on a piece of furniture by placing the first tubular section on a support surface, rotating the first and second elbows relative to the first tubular section so that the first tubular section, first elbow and second elbow are aligned in a first plane, rotating the first and second tubular arms at the first and second elbows to position the first and second tubular arms into respective second and third planes, and rotating the first and second stabilizers at an angle relative to at least one of the second and third planes.

2. The device of claim 1, wherein a height of the first and second tubular arms is adjustable relative to the first tabular section.

3. The device of claim 2, wherein the first tubular section comprises a first tubular section member and a second tubular section member, the first and second tubular section members rotatably couples together at respective ends thereof.

4. The device of claim 2, wherein first tubular section and first and second elbows are unitarily formed.

5. The device of claim 1, wherein the first and second arms are generally U-shaped.

6. The device of claim 1, wherein at least one of the sections is generally C-shaped.

7. The device of claim 1, wherein each of the sections has a circular cross-section.

8. The device of claim 1, wherein the sections are movable to place the device into a substantial flat configuration.

9. The device of claim 1, wherein the sections are rotatable relative to each other to collapse the device into a substantially flat configuration.

10. The device of claim 1, wherein at least one of said sections includes a user accessory.

11. The device of claim 10, wherein the user accessory is an enhanced gripping surface.

12. A device for facilitating movement of a user between upright and seated positions or laying and seated positions, the device mountable on a piece of furniture and comprising:
a U-shaped tubular section including an elongated center portion;
a first stabilizer rotatably coupled to a first end of the U-shaped tubular section and a second stabilizer rotatably coupled to a second end of the U-shaped tubular section,
whereby, the device may be mounted on a piece of furniture by rotating the first and second stabilizers at an angle relative to a longitudinal axis of the elongated center portion of the U-shaped tubular member, and positioning each stabilizer under at least one cushion of furniture on a support surface.

13. The device of claim 12, wherein at least one of the sections is generally C-shaped.

14. The device of claim 12, wherein each of the sections has a circular cross-section.

15. The device of claim 12, wherein the sections are rotatable relative to each other to collapse the device into a substantially flat configuration.

16. The device of claim 12, wherein at least one of said sections includes a user accessory.

17. The device of claim 16, wherein the user accessory is as enhanced gripping surface.
